(19) United States
(12) Patent Application Publication
(10) Pub. No.: US 2026/0116894 A1
(43) Pub. Date: Apr. 30, 2026

(54) METHOD FOR MAKING ORGANIC METAL SKELETON MATERIAL EMBEDDED WITH NANOMETAL, LITHIUM-ION BATTERY ANODE MATERIAL AND ANODE-FREE LITHIUM-ION BATTERY

(71) Applicants: HON HAI PRECISION INDUSTRY CO., LTD., New Taipei (TW); SolidEdge Solution Inc., Hsinchu (TW)

(72) Inventors: PIN-HAN WANG, Hsinchu (TW); WEI-CHAO CHEN, Hsinchu (TW); TSENG-LUNG CHANG, Hsinchu (TW); CHENG-YU WANG, Hsinchu (TW); JENG-KUEI CHANG, Hsinchu (TW)

(21) Appl. No.: 19/011,835

(22) Filed: Jan. 7, 2025

(30) Foreign Application Priority Data
Oct. 25, 2024 (TW) 113140923

(51) Int. Cl. C07F 1/08; H01M 10/0525

(52) U.S. Cl. CPC C07F 1/08; H01M 10/0525

(57) ABSTRACT

A method for preparing an organic metal skeleton material embedded with nanometal, comprising: S1: making a precursor comprising a mixed solution of a metal salt and an organic ligand; S2: providing an adjusting solution, mixing and causing reactions the adjusting solution with the precursor so that the adjusting solution makes the precursor mixed solution have a pH value ranged from 3 to 7, thereby forming an organic metal skeleton material; and S3: dispersing the organic metal skeleton material in a hydrophobic solvent, then adding a metal salt solution, drying the organic metal skeleton material and the metal salt after adsorption, and causing a metal reduction reaction in a gas environment to form an internal organic metal skeleton material embedded with nanometals.

### CROSS-REFERENCE TO RELATED APPLICATIONS

This application claims all benefits accruing under 35 U.S.C. § 119 from TW patent application No. 113140923, filed on Oct. 25, 2024, in the TW Intellectual Property Office, the contents of which are hereby incorporated by reference.

### FIELD

The disclosure relates to a method for making an organic metal skeleton material embedded with nanometal, an anode material for a lithium-ion battery, and an anode-free lithium-ion battery.

### BACKGROUND

Existing common electronic products use lithium-ion batteries as driving power sources. With the increase in energy demand, the development of high-energy lithium batteries has been promoted. Many different anode materials have been developed in terms of material capacity improvement. Therefore, in order to further improve the volumetric energy density of batteries, a lot research has been focused on non-anode and lithium metal batteries. However, due to the uncontrollable growth of lithium dendrites, and the composition, structure, and thickness of the solid electrolyte interphase layer (SEI) changes during the discharge process, these lead to low Coulombic efficiency (CE) and deterioration of cycle characteristics, and eventually resulting in a large amount of ineffective dead lithium and the generation of lithium dendrites, which greatly limits the practical applications of anodes and lithium metal anodes.

Therefore, in order to manipulate the plating/stripping characteristics of lithium ions in non-anode and lithium metal anodes, researchers have developed various functional electrolyte additives. For example, the addition of LiNO₃ can accelerate the formation of the Li₃N inorganic SEI layer. This inorganic SEI layer has a high ionic conductivity and a high Young's modulus, which is enough to inhibit the growth of lithium dendrites and promote uniform conduction of lithium ions. Researchers have also tried to construct an elastic three-dimensional hole structure to generate stress through a three-dimensional hole structure to eliminate lithium dendrites. Despite of the progress made in recent years, anode-free and lithium metal anodes with stable cycle life of more than 400 cycles at an actual current density of 1 mA/cm⁻² are still a huge challenge.

### BRIEF DESCRIPTION OF THE DRAWINGS

Implementations of the present technology will now be described, by way of example only, with reference to the attached figures, wherein:

FIG. 1 is a flow chart of a method for preparing an organic metal skeleton material embedded with nanometal provided by an embodiment of the present disclosure.

FIG. 2 shows XRD patterns of organic metal skeleton material synthesized by using different regulator equivalents.

FIG. 3 is a scanning electron microscope photograph of an organic metal skeleton material no regulator added.

FIG. 4 is a scanning electron microscope photo of an organic metal skeleton material with two equivalents of regulator added.

FIG. 5 is a scanning electron microscope photo of an organic metal skeleton material with 20 equivalents of regulator added.

FIG. 6 shows a test curve of an organic metal skeleton material adjusted by selecting 0, 2, and 20 equivalents of regulators (Htemp_EH_0 equivalent, 2 equivalents, and 20 equivalents) to modify a copper foil respectively, and followed by performing a cycle testing through lithium copper half cells.

FIG. 7 is an XRD pattern of silver embedded in the holes of the organic metal skeleton material (Ag 150° C. @Htemp_EH_20 equivalent, Ag 120° C. @Htemp_EH_20 equivalent).

FIG. 8 is a lithium copper half-cell cycle life test diagram in comparison with a modified layer without silver embedded Htemp_EH_20 equivalent, and a modified layer with Ag 120° C. @Htemp_EH_20 equivalent, and a modified layer with Ag 150° C. @Htemp_EH_20 equivalent.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean “at least one.”

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts have been exaggerated to better illustrate details and features of the present disclosure.

Several definitions that apply throughout this disclosure will now be presented.

The term “substantially” is defined to be essentially conforming to the particular dimension, shape, or other feature which is described, such that the component need not be exactly or strictly conforming to such a feature. The term “comprise,” when utilized, means “comprise, but not necessarily limited to”; it specifically indicates open-ended inclusion or membership in the so-described combination, group, series, and the like.

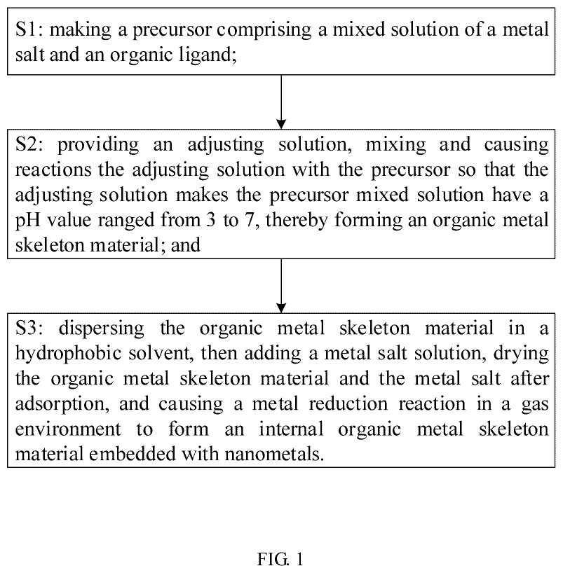

Referring to FIG. 1, an embodiment of the present disclosure provides a method for preparing an organic metal skeleton material embedded with nanometal, which includes the following steps:
S1: making a precursor which is a mixed solution of a metal salt and an organic ligand;
S2: providing an adjusting solution, mix and react the adjusting solution with the precursor, and the adjusting solution makes the precursor mixed solution have a pH value ranged from 3 to 7, thereby forming an organic metal skeleton material;
S3: dispersing the organic metal skeleton material in a hydrophobic solvent, then adding a metal salt solution, drying the organic metal skeleton material and the metal salt after drying it after adsorption, and a metal reduction reaction is happened in a gas environment to form an internal organic metal skeleton material embedded with nanometals.

The organic metal skeleton material can be Cu-BTC, UIO-66, UIO-67, ZIF-8 or ZIF-12.

Step S1 comprises the following sub steps:
S11: adding the metal salt to the organic solvent to dissolve and form a first precursor solution with a concentration of 0.02˜0.5M;
S12: adding the organic ligand to the organic solvent to dissolve and form a second precursor solution with a concentration of 0.013˜0.5M;
S13: mixing the first precursor solution and the second precursor solution evenly to form a precursor.

In step S1, in one embodiment the organic metal skeleton material is Cu-BTC, the metal salt can be copper nitrate, copper acetate, copper sulfate, etc., the organic ligand is trimesic acid, and the organic solvent can be a mixture of water and ethanol. In another embodiment, the organic metal skeleton material is UIO-66, the metal salt can be zirconium nitrate, zirconium acetate, zirconium sulfate, zirconium chloride, etc., and its organic ligand is terephthalic acid, and the organic solvent can be dimethylformyl (DMF). In yet another embodiment, the organic metal skeleton material is UIO-67, the metal salt can be zirconium nitrate, zirconium acetate, zirconium sulfate, zirconium chloride, etc., and its organic ligand is 4, 4′ biphenyldicarboxylic acid, the organic solvent can be DMF. In still another embodiment, the organic metal skeleton material is ZIF-8, the metal salt can be zinc nitrate, zinc acetate, zinc sulfate, etc., and its organic ligand is imidazole, the organic solvent can be DMF. In further another embodiment, the organic metal skeleton material is ZIF-12, the metal salt can be cobalt nitrate, cobalt acetate, cobalt sulfate, cobalt chloride, etc., and its organic ligand is benzimidazole, and the organic solvent can be DMF. It can be understood that the organic solvent can be reasonably selected according to the type of metal salt.

In step S2, an adjusting solution is provided, and the adjusting solution is mixed with the precursor and reacted. The function of the adjusting agent in the adjusting solution is to adjust the pH value of the mixed solution, so that the pH value of the precursor is ranged from 3 to 7. When the organic metal skeleton material is Cu-BTC, the regulating agent in the regulating solution can be acetic acid/sodium acetate, benzoic acid/sodium benzoate, sodium formate, lauric acid, sodium bisulfate or sodium hydroxide, etc. Specifically, when acetic acid/sodium acetate is selected as the regulator, the molar ratio of acetic acid:sodium acetate is ranged from 1:1 to 6:1. When the organic metal skeleton material is other materials, other regulators can be reasonably selected as long as the pH value of the mixed solution can be adjusted to 3-7.

In step S2, add different equivalents of regulators to the precursor mixed solution, mix and stir evenly. The equivalent ratio of the regulator to the metal salt is greater than 0 and less than or equal to 25. After mixing, the mixture is placed in an oven at 100 to 120° C. for synthesis reaction for 12 to 36 hours. The solution is then taken out, centrifuged several times, washed with solvent and then dried to obtain an organic metal skeleton material.

In step S2, the regulating solution is used as a growth regulating solvent for the organic metal skeleton material to effectively control the growth size of the organic metal skeleton and make it nanonized. The reaction mechanism is that the growth size of the organic metal skeleton will vary with the pH of the solution. In an acidic environment, the deprotonation of the organic ligand can be inhibited, causing the size of the organic metal skeleton to grow larger; if under alkaline reaction conditions, the organic ligand will The body is easily deprotonated, making it easy for the central metal to bond and nucleate with organic ligands. Because the nucleation speed is fast, the growth size of the organic metal skeleton is relatively small. The growth size of the organometallic skeleton crystals can be controlled by changing the equivalent number of the modulator in the adjusting solution. When the concentration of the adjusting solution decreases, its role changes to a termination agent, so that the organic metal skeleton no longer grows and achieves the effect of nano-micronization.

The organic metal skeleton material prepared in step (2) can be an organic metal skeleton material with a pore size ranging from 5 Å to 20 Å. The organic metal skeleton material can be Cu-BTC, UIO-66 (6 Å˜11 Å), UIO-67 (12 Å˜16 Å), ZIF-8 (11.6 Å), ZIF-12 (14.64 Å), etc. A sort of.

In step S3, the dried product is first dispersed in a hydrophobic solvent, and then a metal salt solution is added, wherein the weight percentage of the metal salt addition to the organic metal skeleton material is greater than 0 and less than or equal to 20 wt. %. The hydrophobic solvent can be n-hexane, benzene, toluene, xylene, chlorobenzene, dichlorobenzene, cyclohexane, chloroform) and carbon tetrachloride (Tetrachloride), etc. The metal salt solution may be a salt solution of a lithiophilic metal, for example, one of the salt solutions of silver (Ag), gold (Au), zinc (Zn), tin (Sn), nickel (Ni), platinum (Pt), etc. species or several species. Specifically, the metal salt solution can be silver nitrate, silver sulfate, gold-chloroauric acid (HAuCl₄), gold hydroxide (Au(OH)₃), platinum-chloroplatinic acid (H₂PtCl₆), potassium chloroplatinate (K₂PtCl₆), zinc nitrate, zinc sulfate, etc.

In step S3, utilizing the hydrophilic characteristics of the pores of the organic metal skeleton material, the metal salt solution is effectively adsorbed into the pores of the organic metal skeleton material under capillary action, and the metal salt solution will not aggregate on the surface of the organic metal skeleton material. When the adsorption of the metal salt solution is completed, it is pumped, filtered and dried, and then sent to the tubular furnace, and the reduction mixed gas Ar/H₂ is introduced, and then the metal reduction reaction is performed at 100˜150° C. for 0˜2 hours to obtain the organometallic skeleton material embedded with metal nanoparticles.

### Detail Embodiment

A method for preparing a Cu-BTC organic metal skeleton material embedded with nanometal silver is provided. In step S1, adding copper nitrate (Cu(NO₃)₂) to a mixed solution of water and ethanol to dissolve and configure it into a precursor solution with a concentration of 0.12M; step S2: adding trimesic acid to water Dissolve in the mixed solution with ethanol to form a precursor solution with a concentration of 0.08M; step S3: mixing the two precursor solutions evenly to form a precursor mixed solution.

In step S2, a adjusting solution of acetic acid/sodium acetate solution is provided, in which the molar ratio of acetic acid as a conditioning agent:sodium acetate is 3:1. Add different equivalents of regulators to the precursor mixed solution, mix and stir evenly. The equivalent ratio of regulator to metal salt is 20. After mixing, place it in a 120° C. oven for synthesis reaction for 24 hours. The solution is then taken out, centrifuged several times, washed with solvent and dried to obtain Cu-BTC.

In step S3, Cu-BTC is first dispersed in a hydrophobic n-hexane solvent, and then a silver nitrate-alcohol solution is added, where the amount of silver nitrate added is 10 wt % of Cu-BTC. The silver nitrate solution is effectively adsorbed into the pores of Cu-BTC under capillary action, and the silver nitrate solution will not aggregate on the surface of Cu-BTC. When the adsorption of the silver nitrate solution is completed, it is pumped, filtered and dried, and then sent to the tubular furnace, and the reducing mixed gas Ar/H₂ is introduced, and then the silver reduction reaction is performed at 120° C. for 2 hours to obtain Cu-BTC (Ag@Cu-BTC) embedded with nanosilver anode material.

The embodiment of the present disclosure further provides a method for preparing a battery anode, which includes the following steps:
M1: providing a precursor mixed solution of a metal salt and an organic ligand;
M2: providing an adjusting solution, mixing and reacting the adjusting solution with the precursor mixed solution, and the adjusting solution makes the precursor mixed solution have a pH value of 3-7, and the reaction forms an organic metal skeleton material;
M3: dispersing the organic metal skeleton material in a hydrophobic solvent, then adding a metal salt solution, drying it after adsorption, and performing a metal reduction reaction in a gas environment to form an internal Organic metal skeleton material embedded with nanometal;
M4: mixing the organic metal skeleton material embedded with nanometal with conductive carbon black Super P and binder carboxymethyl cellulose (CMC) to form a anode modification layer slurry;
M5: coating the anode modification layer slurry on the current collector to form a modification layer.

Steps M1 to M3 are exactly the same as the S1 to S3 of the preparation method of organic metal skeleton materials embedded with nanometals disclosed above, and will not be described again here.

In step M4, the organic metal skeleton material embedded with nanometal is activated at 120° C. to remove moisture. The organic metal skeleton material embedded with nanometal is mixed with conductive carbon black Super P and adhesive carboxymethyl cellulose in a weight ratio of 7:2:1 respectively to form a anode modification layer slurry.

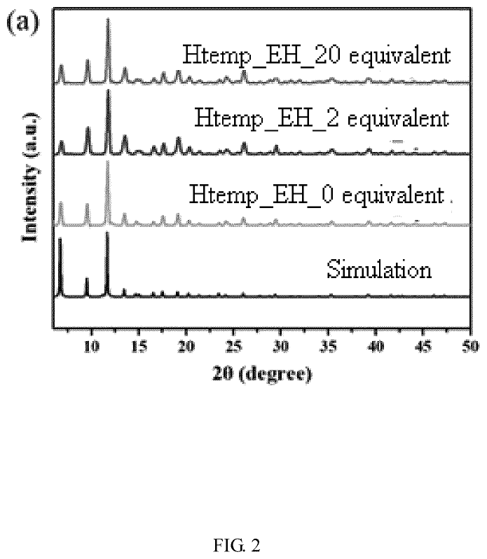

The regulator in FIGS. 2-8 is a mixed solution of acetic acid/sodium acetate, where the molar ratio of acetic acid and sodium acetate is 3:1; the organic metal skeleton is Cu-BTC.

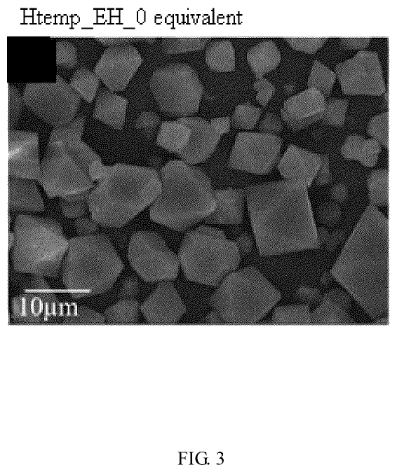

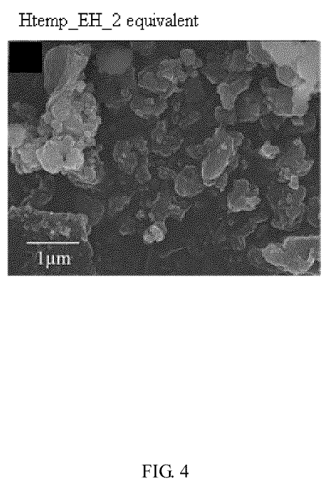

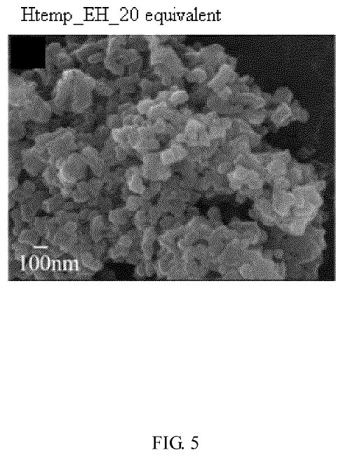

Please refer to FIG. 2, using different amounts of regulators to synthesize organometallic skeleton materials. From the XRD pattern, it can be known that Cu₃BTC₂ can be successfully synthesized by adding different amounts of regulators. Please refer to FIG. 3, FIG. 3 is a scanning electron microscope photo of the organic metal skeleton material without adding a regulator. It can be seen from FIG. 3 that when no regulator is added, the particle size of the organic metal skeleton material is approximately 10 μm. FIG. 4 is a scanning electron microscope photo of the organometallic skeleton material when adding 2 equivalents of regulator. FIG. 5 is a scanning electron microscope photo of the organic metal skeleton material when adding 20 equivalents of regulator. As can be seen from FIGS. 4 and 5, after adding different equivalents of regulators, it can be observed that the organometallic skeleton material has significantly shrunk. Especially when 20 equivalents of regulators are added, the particle size of a single particle of the organometallic skeleton material can be significantly reduced. Shrunk to 1˜200 nm. Organometallic skeleton materials are made up of many single particles that are aggregated. A single particle is the smallest unit of organometallic skeleton materials. In some examples, the particle size of a single particle of the organic metal skeleton material can be significantly reduced to 1˜180 nm; in some examples, the particle size of a single particle of the organic metal skeleton material can be significantly reduced to 1˜150 nm; in some examples In examples, the particle size of a single particle of the organic metal skeleton material can be significantly reduced to 1˜120 nm; in some examples, the particle size of a single particle of the organic metal skeleton material can be significantly reduced to 1˜100 nm; in some examples, the particle size of a single particle of the organic metal skeleton material can be significantly reduced to 1˜80 nm; in some examples, the particle size of a single particle of the organic metal skeleton material can be significantly reduced to 1˜60 nm; in some examples, the particle size of a single particle of the organic metal skeleton material can be significantly reduced to 1˜60 nm; The particle size of a single particle of a metal skeleton material can be significantly reduced to 1˜40 nm; in some examples, the particle size of a single particle of an organic metal skeleton material can be significantly reduced to 1˜20 nm. It can be seen that after adding the regulator, the size of the organic metal skeleton particles can be effectively refined.

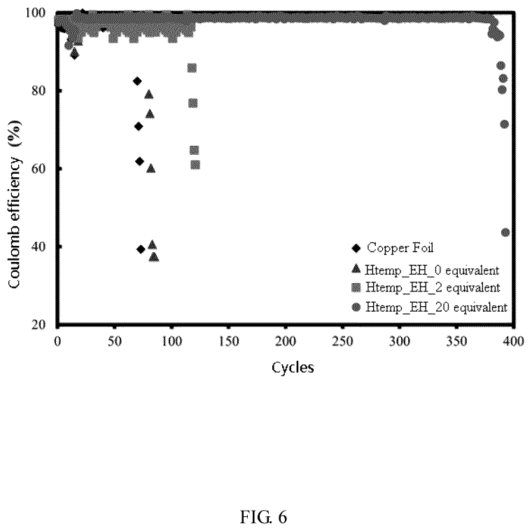

Please refer to FIG. 6, using a mixed solution of water and ethanol as the solvent in a high-temperature process, and using 0, 2, and 20 equivalents of regulators (Htemp_EH_0 equivalent, 2 equivalent, and 20 equivalent) respectively. The organic metal skeleton material is adjusted, and the copper foils were modified separately. After the lithium-copper half-cell cycle test, it can be seen that the Coulombic efficiency of the copper foil that has not been modified by the organic metal skeleton material begins to drop significantly when the cycle test reaches 65 cycles. It can be speculated that, because the surface of the copper foil has not been modified that the lithium ions are not deposited uniformly, resulting in the generation of lithium dendrites. After modifying the copper foil with Htemp_EH_0 equivalent organic metal skeleton material, although the cycle life has been improved, due to the large particles of this organic metal skeleton material, the slurry cannot be evenly covered on the copper foil during coating. The roughness is too high and the coating layer is too thick, resulting in uneven electric field and reduced energy density during operation. Although the cycle life is slightly improved, the Coulombic efficiency begins to decrease after 80 cycles. The copper foil modified with an organic metal skeleton material with an equivalent of Htemp_EH_2 can perform up to 120 cycles in a lithium-copper half-cell test. The cycle life of an organic metal skeleton material with an equivalent of Htemp_EH_20 can even reach 380 cycles and the Coulombic efficiency is still maintained. The holding is at 97.8%.

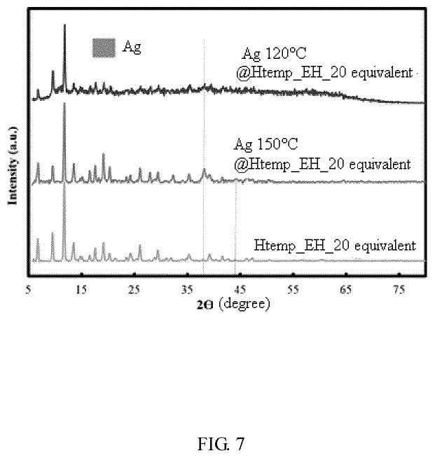

Please refer to FIG. 7. From FIG. 7, it can be found that silver is embedded in the holes of the organic metal skeleton material (Ag 150° C. @Htemp_EH_20 equivalent, Ag 120° C. @Htemp_EH_20 equivalent), and its XRD pattern is at 2θ=38.2° There are obvious diffraction peaks of silver at 44.2°. Therefore, the XRD pattern can prove that silver does exist in the organic metal skeleton material. From the half-maximum width, it can be inferred that when the reduction atmosphere is Ar/H₂, the silver grains reduced at a temperature of 120° C. are smaller than those at 150° C., because at higher temperatures, the diffusion of silver will be more obvious and large silver particles will appear. Therefore, when the reduction temperature drops to 120° C. from 150° C., smaller metallic silver particles with lower aggregation can be obtained.

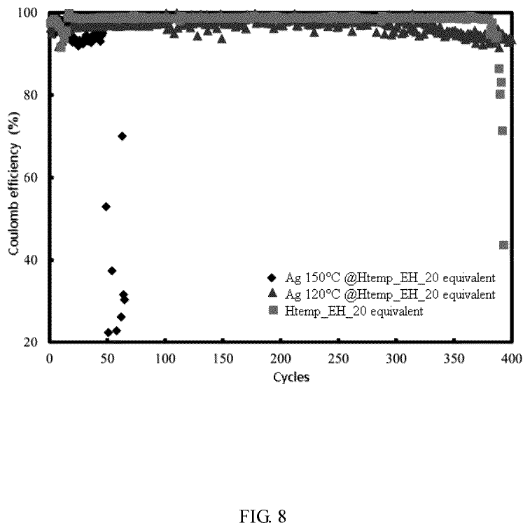

Please refer to FIG. 8, the Ag 150° C.@Htemp_EH_20 battery quickly fails in the first fifty cycles, and the Coulombic efficiency decreases significantly. It is speculated that the reason for the rapid decrease in Coulombic efficiency is due to the use of 150 in the organic metal skeleton. The method of reducing silver at 150° C. can cause the aggregation of silver. After it is added to the modification layer, lithium will not be deposited more uniformly on the modification layer during charging and discharging due to the uneven accumulation of silver's accumulated charge and electric field. In order to solve the problem of silver aggregation due to thermal diffusion under high-temperature reduction, the reduction temperature of embedded silver was lowered from 150° C. to 120° C. As can be seen in the lithium copper half-cell cycle life test chart of the modified layer of silver embedded in Htemp_EH_20 equivalent (Ag 120° C. @Htemp_EH_20 equivalent), lowering the silver reduction temperature can effectively improve its cycle life, and the Coulombic efficiency is at 100 cycles and 200 laps can reach 98.2% and 99.3% respectively. Continuously let the modified layer with Ag 120° C.@Htemp_EH_20 equivalent undergo charge and discharge cycle tests. In the lithium copper half-cell cycle life test chart compared with the modified layer with Htemp_EH_20 equivalent, it can be seen that, about the modified layer without silver embedded in, when the cycle life reaches 400 cycles, the Coulombic efficiency drops significantly and the battery quickly fails within 20 cycles. However, during the cycle life of the silver-containing embedded modification layer, the Coulombic efficiency decline trend is slow and smooth. The Coulomb efficiency remained at 93.8% at 420 laps.

In addition, an embodiment of the present disclosure provides a anode material for a lithium-ion battery, including an organic metal skeleton material embedded with nanometal prepared by the above method. The organic metal skeleton material embedded with nanometal includes an organic metal skeleton and nanometal particles. The organic metal skeleton is formed with a plurality of holes. The size of the organic metal skeleton can be micron or nanometer. The nanometal particles are adsorbed within the multiple pores of the organometallic skeleton. Preferably, the mass percentage of the nanometal particles in the organic metal skeleton is 5%-15%.

The organic metal skeleton is an organic metal skeleton material with a pore size between 5 Å and 20 Å. The organic metal skeleton material can be Cu-BTC, UIO-66 (6 Å˜11 Å), UIO-67 (12 Å˜16 Å), ZIF-8 (11.6 Å), or ZIF-12 (14.64 Å).

The nanometal particles are preferably lithiophilic metal particles, such as silver (Ag), gold (Au), zinc (Zn), tin (Sn), nickel (Ni), platinum (Pt), etc.

In this embodiment, the organic metal skeleton embedded with nanometal is Cu-BTC embedded with silver nanoparticles. Cu-BTC has multiple holes, and silver nanoparticles are adsorbed in the multiple holes of Cu-BTC.

An embodiment of the present disclosure provides a battery, which includes a current collector and a modification layer disposed on the surface of the current collector. The modification layer includes the organic metal skeleton material embedded with nanometals described in this embodiment, conductive carbon black, super P and adhesive carboxymethylcellulose. Using a slurry containing an organic metal skeleton material embedded with nanometals as a current collector modification layer can homogenize the electrochemical deposition of lithium ions on the anode to avoid the generation of dead lithium.

The battery provided by the embodiment of the present disclosure can be an anode-free battery (Anode-free) or a lithium metal battery.

The present disclosure utilizes the porous characteristics of the organic metal skeleton and its relatively high Young's modulus (˜400 kPa), and micronizes the material particles through a regulator to evenly disperse the organic metal skeleton material in the slurry. Also by embedding lithiophilic metals in the holes, the holes of the organic metal skeleton are highly lithiophilic, and the lithiophilic ion particles embedded in the holes are less likely to cause metal particles to break down due to repeated charging and discharging, thereby stabilizing the material's properties over long cycles. This slurry can be used as a current collector modification layer in Anode-free batteries and lithium metal batteries. It can homogenize the electrochemical deposition of lithium ions on the anode to avoid the generation of dead lithium, and can effectively suppress charge and discharge. Lithium dendrites are generated during the process, and can also provide higher energy density batteries.

Moreover, the organic metal skeleton material is dispersed in a hydrophobic solvent using a dual solvent method, and then the prepared metal salt solution utilizes the hydrophilicity of the pores of the organic metal skeleton material to diffuse into the pores of the organic metal skeleton material under capillary action. Then perform low temperature reduction. Using this dual-solvent method can greatly improve the embedding of metals in the pores of organic metal skeleton materials and avoid the accumulation of metal particles on the surface.

It is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

Depending on the embodiment, certain of the steps of a method described may be removed, others may be added, and the sequence of steps may be altered. The description and the claims drawn to a method may comprise some indication in reference to certain steps. However, the indication used is only to be viewed for identification purposes and not as a suggestion as to an order for the steps.

What is claimed is:

1. A method for preparing an organic metal skeleton material embedded with nanometal, comprising:
S1: making a precursor comprising a mixed solution of a metal salt and an organic ligand;
S2: providing an adjusting solution, mixing and causing reactions the adjusting solution with the precursor so that the adjusting solution makes the precursor mixed solution have a pH value ranged from 3 to 7, thereby forming an organic metal skeleton material; and
S3: dispersing the organic metal skeleton material in a hydrophobic solvent, then adding a metal salt solution, drying the organic metal skeleton material and the metal salt after adsorption, and causing a metal reduction reaction in a gas environment to form an internal organic metal skeleton material embedded with nanometals.

2. The method of claim 1, wherein step S1 comprises:
adding the metal salt to the organic solvent to dissolve and form a first precursor solution with a concentration of 0.02˜0.5M;
adding the organic ligand to the organic solvent to dissolve and form a second precursor solution with a concentration of 0.013˜0.5M;
mixing the first precursor solution and the second precursor solution evenly to form a precursor.

3. The method of claim 1, wherein in step S1, a material of the organic metal skeleton is Cu-BTC, the metal salt is copper nitrate, copper acetate, or copper sulfate.

4. The method of claim 1, wherein in step S1, a material of the organic metal skeleton is UIO-66, the metal salt is zirconium nitrate, zirconium acetate, zirconium sulfate, or zirconium chloride.

5. The method of claim 1, wherein in step S1, a material of the organic metal skeleton is UIO-67, the metal salt is zirconium nitrate, zirconium acetate, zirconium sulfate, or zirconium chloride.

6. The method of claim 1, wherein in step S1, a material of the organic metal skeleton is ZIF-8, the metal salt is zinc nitrate, zinc acetate, or zinc sulfate.

7. The method of claim 1, wherein in step S1, a material of the organic metal skeleton is ZIF-12, the metal salt is cobalt nitrate, cobalt acetate, cobalt sulfate or cobalt chloride.

8. The method of claim 1, wherein in S2, the adjusting solution comprises a regulator, and an equivalent ratio of the regulator to the metal salt in the adjusting solution is greater than 0 and less than or equal to 25.

9. The method of claim 8, wherein in S2, the adjusting solution and the precursor mixed solution are mixed and placed in an oven with a temperature ranged from 100 to 120° C. for synthesis reactions for 12˜24 hours.

10. The method of claim 1, wherein in S3, a weight percentage of an added amount of the metal salt to the organic metal skeleton material is greater than zero (0) and less than or equal to 20 wt. %.

11. The method of claim 1, wherein the metal salt solution is a salt solution of a lithiophilic metal.

12. The method of claim 1, wherein the hydrophobic solvent is at least one of n-hexane, benzene, toluene, xylene, chlorobenzene, dichlorobenzene, cyclohexane, chloroform and carbon tetrachloride.

13. A anode material for lithium-ion batteries, comprising:
an organic metal skeleton material embedded with nanometal, wherein the organic metal skeleton material embedded with nanometal comprises a plurality of organic metal skeletons and a plurality of nanometal particles, each of the plurality of organic metal skeletons comprises a plurality of holes, and the plurality of nanometal particles are embedded in the plurality of holes of the organic metal skeletons.

14. The anode material for lithium-ion batteries of claim 13, wherein a material of the organic metal skeletons is Cu-BTC, UIO-66, UIO-67, ZIF-8 or ZIF-12.

15. The anode material for lithium-ion batteries of claim 13, wherein a mass percentage of the plurality of nanometal particles in the organic metal skeleton is ranged from 5% to 15%.

16. The anode material for lithium-ion batteries of claim 13, wherein a particle size of a single particle of the organic metal skeleton is ranged from 1 nm to 200 nm.

17. A negative-electrode-free lithium-ion battery comprising:
a current collector; and
a modification layer located on a surface of the current collector and comprising an organic metal skeleton material embedded with nanometal, a conductive agent and an adhesive, wherein the organic metal skeleton material embedded with nanometal comprises a plurality of organic metal skeletons and a plurality of nanometal particles, each of the plurality of organic metal skeletons comprises a plurality of holes, and the plurality of nanometal particles are embedded in the plurality of holes of the organic metal skeletons.

18. The negative-electrode-free lithium-ion battery of claim 17, wherein the conductive agent is Super P and the adhesive is carboxymethyl cellulose.
